(19) United States
(12) Patent Application Publication
(10) Pub. No.: US 2026/0238992 A1
(43) Pub. Date: Aug. 13, 2026

(54) METHODS AND SYSTEMS FOR AI MODEL DOWNLOAD FOR BEYOND 5G 3GPP SYSTEMS

(71) Applicant: Samsung Electronics Co., Ltd., Suwon-si (KR)

(72) Inventors: Ashwini KUMAR, Bangalore (IN); Sripada KADAMBAR, Bangalore (IN); Ashok Kumar Reddy CHAVVA, Bangalore (IN)

(21) Appl. No.: 19/457,733

(22) Filed: Jan. 23, 2026

Related U.S. Application Data
(63) Continuation of application No. PCT/KR2025/000091, filed on Jan. 3, 2025.

(30) Foreign Application Priority Data
Jan. 3, 2024 (IN) 202441000554
Dec. 23, 2024 (IN) 2024 41000554

(51) Int. Cl. H04W 8/24; H04W 24/10

(52) U.S. Cl. CPC H04W 8/24; H04W 24/10

(57) ABSTRACT

Methods and systems for managing and sharing artificial intelligence (AI) models in wireless networks are provided. A method for a target base station to download and transmit configuration-specific sub-blocks of AI models to user equipment (UE) based on the UE's capabilities and previous configuration data is provided. The server managing the AI models splits them into blocks based on input and configuration parameters, categorizing them as common or configuration-specific sub-blocks for optimized delivery. The UE receives these sub-blocks along with execution information and configures the AI model accordingly.

### CROSS-REFERENCE TO RELATED APPLICATION(S)

This application is a continuation application, claiming priority under 35 U.S.C. § 365(c), of an International application No. PCT/KR2025/000091, filed on January 3, 2025, which is based on and claims the benefit of an Indian Provisional patent application number 202441000554, filed on January 3, 2024, in the Indian Intellectual Property Office, and of an Indian Complete patent application number 202441000554, filed on December 23, 2024, in the Indian Intellectual Property Office, the disclosure of each of which is incorporated by reference herein in its entirety.

### BACKGROUND

### 1. Field

The disclosure relates to the field of mobile communication systems. More particularly, the disclosure relates to a method and system for sharing artificial intelligence (AI) models.

### 2. Description of Related Art

The integration of artificial intelligence (AI) into wireless systems represents a significant leap in enhancing the capacity, efficiency, and adaptability of communication networks. Within the framework of the 3^{rd} generation partnership project (3GPP), AI has the potential to address several critical challenges in wireless communication, such as dynamic channel conditions, resource allocation, and optimization of system performance.

In the context of 3GPP Release-18, AI is becoming a central component of future wireless systems, with study items being initiated to explore novel AI-based use cases. The applications of AI in wireless communication systems may broadly be categorized into one-sided and two-sided operations. One-sided operations involve the deployment of an AI model at either a base station (BS) or a user equipment (UE), where AI-based operations, such as channel state information (CSI) prediction, are performed independently. In contrast, two-sided operations involve a collaborative deployment of AI models at both the BS and the UE, as exemplified by CSI compression, where both entities work together to optimize system performance.

The deployment of AI models in wireless systems is subject to strategic considerations to optimize performance and address inherent limitations. Once AI models are trained, it is critical to ensure that they are deployed on the appropriate devices either at the BS or the UE. For operations, such as CSI compression or prediction, where real-time decision-making is essential, it is preferable for the trained AI models to reside on the UE, reducing latency in the execution of AI-based tasks. However, UEs are often constrained by limited memory capacity, which makes it impractical to store a wide range of AI models. To address this challenge, 3GPP has proposed, within the scope of Release-18, that UEs should be capable of either storing AI models locally or downloading them from the BS as needed.

Storing AI models at the BS presents a viable solution, given the BS's higher computational power and memory resources compared to the UE. The BS may efficiently train AI models based on a broad spectrum of network data and dynamic field scenarios, ensuring that the models remain up-to-date and optimized. On the other hand, UEs may benefit from downloading AI models from the BS, allowing them to access the latest models tailored to evolving network conditions. This dynamic model distribution approach enhances system efficiency by ensuring that UEs may perform AI-based tasks without the limitations posed by local storage capacity.

However, the process of downloading and configuring AI models introduces potential challenges, particularly when frequent configuration changes occur, such as during handovers or carrier aggregation (CA) scenarios. In situations where the UE switches between BSs with different reporting periodicities or operates across multiple component carriers, the need to download and reconfigure models may lead to inefficiencies, increased bandwidth consumption, and potential service disruptions. Addressing these challenges requires a more intelligent approach to AI model management.

A potential solution to these inefficiencies involves optimizing the AI model download process by leveraging the commonalities between models for similar configurations. Rather than downloading entirely new models for each configuration change, an intelligent approach could involve selectively transferring the differentiating components of the models. This approach would reduce bandwidth requirements, accelerate the reconfiguration process, and enhance the responsiveness of the wireless network.

While the integration of AI into wireless systems holds significant promise for improving network efficiency and adaptability, there remain challenges associated with the deployment, download, and reconfiguration of AI models. Therefore, there is a need for a more efficient and intelligent method of managing AI model downloads and configurations in wireless networks.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspects of the disclosure is to provide a method and system for sharing artificial intelligence (AI) models.

Additional aspects will be set forth in part in the description which follows and, in part, will be apparent from the description, or may be learned by practice of the presented embodiments.

In accordance with an aspect of the disclosure, a method for sharing artificial intelligence (AI) models by a target base station is provided. The method includes receiving user equipment (UE) capability information from a UE, receiving previous UE configuration data from a serving base station, downloading, from a server, one or more configuration specific blocks corresponding to at least one AI model at least based on the previous UE configuration data and the UE capability information, and transmitting one or more configuration specific blocks along with CSIReportConfig to the UE.

In accordance with an aspect of the disclosure, a method for managing artificial intelligence (AI) models by a server is provided. The method includes splitting an AI model into a plurality of blocks based on at least one input parameter and at least one configuration parameter, and categorizing the plurality of blocks as common block or a configuration specific block for a base station at least based on dependency of the base station on the at least one input parameter and the at least one configuration parameter.

In accordance with an aspect of the disclosure, a method for loading artificial intelligence (AI) models by a user equipment (UE) is provided. The method includes transmitting UE capability information to a target base station, receiving one or more configuration specific blocks corresponding to an AI model along with CSI report configuration information from the target base station, wherein the CSI report configuration information at least comprises AI model execution information, and configuring the AI model at least based on the one or more configuration specific sub-blocks and the AI model execution information within the CSI report configuration information.

In accordance with an aspect of the disclosure, a base station for sharing artificial intelligence (AI) models is provided. The base station includes memory, including one or more storage media, storing instructions and at least one processor communicatively coupled to the memory, wherein the instructions, when executed by the at least one processor individually or collectively, cause the base station to receive user equipment (UE) capability information from a UE, receive previous UE configuration data from a serving base station, download, from a server, one or more configuration specific sub-blocks corresponding to at least one AI model at least based on the previous UE configuration data and the UE capability information, and transmit one or more configuration specific sub-blocks along with CSI report configuration information to the UE.

In accordance with an aspect of the disclosure, a server for managing artificial intelligence (AI) models is provided. The server includes memory, including one or more storage media, storing instructions and at least one processor communicatively coupled to the memory, wherein the instructions, when executed by the at least one processor individually or collectively, cause the base station to split an AI model into a plurality of blocks based on at least one input parameter and at least one configuration parameter, and categorize the plurality of blocks as common block or a configuration specific block for a base station at least based on dependency of the base station on the at least one input parameter and the at least one configuration parameter.

In accordance with an aspect of the disclosure, a user equipment (UE) for loading of artificial intelligence (AI) models is provided. The UE includes memory, including one or more storage media, storing instructions and at least one processor communicatively coupled to the memory, wherein the instructions, when executed by the at least one processor individually or collectively, cause the base station to transmit UE capability information to a target base station, receive one or more configuration specific sub-blocks corresponding to an AI model along with CSI report configuration information from the target base station, wherein the CSI report configuration information at least comprises AI model execution information, and configured the AI model based on the one or more configuration specific blocks and the AI model execution information within the CSI report configuration information.

In accordance with an aspect of the disclosure, one or more non-transitory computer-readable storage media storing one or more computer programs including computer-executable instruction that, when executed by one or more processors of a target base station individually or collectively, cause the target base station to perform operations of sharing artificial intelligence (AI) models are provided. The operations include receiving user equipment (UE) capability information from a UE, receiving previous UE configuration data from a serving base station, downloading, from a server, one or more configuration specific sub-blocks corresponding to at least one AI model at least based on the previous UE configuration data and the UE capability information, and transmitting one or more configuration specific sub-blocks along with channel state information (CSI) report configuration information to the UE.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates an environment for sharing artificial intelligence (AI) models according to an embodiment of the disclosure;

FIG. 2A illustrates a signaling diagram for sharing artificial intelligence (AI) models according to an embodiment of the disclosure;

FIG. 2B illustrates a signaling diagram for loading common blocks and configuration-specific blocks of artificial intelligence (AI) models according to an embodiment of the disclosure;

FIG. 2C illustrates a signaling diagram for sharing configuration-specific blocks of artificial intelligence (AI) models according to an embodiment of the disclosure;

FIG. 3 illustrates splitting of one or more artificial intelligence (AI) configuration blocks of AI models according to an embodiment of the disclosure;

FIG. 4 illustrates a block diagram of a base station for sharing artificial intelligence (AI) models according to an embodiment of the disclosure;

FIG. 5 illustrates a block diagram of a server for managing artificial intelligence (AI) models according to an embodiment of the disclosure;

FIG. 6 illustrates a block diagram of a user equipment for loading artificial intelligence (AI) models according to an embodiment of the disclosure;

FIG. 7 illustrates a flowchart for a method for sharing artificial intelligence (AI) models by a target base station according to an embodiment of the disclosure;

FIG. 8 illustrates a flowchart for a method for managing artificial intelligence (AI) models by a server according to an embodiment of the disclosure; and

FIG. 9 illustrates a flowchart for a method for loading artificial intelligence (AI) models by a user equipment according to an embodiment of the disclosure.

The same reference numerals are used to represent the same elements throughout the drawings.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein t can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

While the disclosure is susceptible to various modifications and alternative forms, specific embodiments thereof have been shown by way of example in the drawings and will be described below. It can be understood, however, that it is not intended to limit the disclosure to the particular forms disclosed, but on the contrary, the disclosure is to cover a plurality of modifications, equivalents, and alternative falling within the spirit and the scope of the disclosure.

The terms "comprise", "comprising", or any other variations thereof, are intended to cover a non-exclusive inclusion, such that a setup, device, or method that comprises a list of components or steps does not include only those components or steps but may include other components or steps not expressly listed or inherent to such setup or device or method. In other words, one or more elements in a device or system or apparatus proceeded by "comprises ... a" does not, without more constraints, preclude the existence of other elements or additional elements in the device or system or apparatus.

In the following detailed description of the embodiments of the disclosure, reference is made to the accompanying drawings that form a part thereof, and in which are shown by way of illustration specific embodiments in which the disclosure may be practiced. These embodiments are described in sufficient detail to enable those skilled in the art to practice the disclosure, and it is to be understood that other embodiments may be utilized and that changes may be made without departing from the scope of the disclosure. The following description is, therefore, not to be taken in a limiting sense.

The terminology "artificial intelligence (AI) model", "convolution neural network", and "CNN" are interchangeably used throughout the specification. The terminology "configuration blocks", "AI configuration specific blocks" and "configuration-specific blocks" are interchangeably used throughout the specification. The terminology "AI model blocks" and "blocks", are interchangeably used throughout the specification.

The AI model may be a combination of hardware module and software module. The hardware module may comprise necessary circuitry to perform the functionality discussed in the embodiments below.

Embodiments of the disclosure relate to methods and systems for efficiently managing and sharing artificial intelligence (AI) models in wireless networks. Specifically, the disclosure provides a method for a target base station to download and transmit configuration-specific blocks of AI models to a user equipment (UE) based on the UE's capabilities and previous configuration data. The server managing the AI models splits them into blocks based on input parameters and configuration parameters and categorizes the blocks as common or configuration-specific blocks for optimized delivery. The UE receives these blocks along with execution information and configures the AI model accordingly thereby optimizing bandwidth usage, reducing reconfiguration time, and enhancing the overall performance of AI-driven wireless systems.

Instead of downloading entirely new models each time a configuration changes, the disclosure leverages the similarities between AI models of different configurations by identifying shared components across models and only transferring the unique blocks that differ between them. This significantly reduces the amount of bandwidth required and accelerates the reconfiguration process by minimizing redundant data transfer. Further, the methods and systems of the disclosure enable more efficient and responsive AI model management within wireless networks and improve both resource utilization and overall performance. Moreover, the methods and systems of the disclosure enhance the flexibility and scalability of AI applications in dynamic wireless environments.

The disclosure relates generally to the field of artificial intelligence (AI), and more particularly to methods and systems for downloading AI model for beyond-5G 3GPP systems.

The integration of artificial intelligence (AI) in wireless systems marks a significant advancement poised to enhance system capacity and efficiency within the 3rd generation partnership project (3GPP) framework. This introduction brings forth a myriad of applications that showcase the transformative potential of AI in this domain. Among the notable applications are AI-based channel state information (CSI) prediction, which leverages machine learning algorithms to forecast wireless channel conditions, and AI-based CSI compression, where sophisticated techniques are employed to optimize the storage and transmission of CSI data. Additionally, AI is harnessed for Beam management, facilitating intelligent beamforming strategies to enhance signal quality and coverage. Another crucial application is AI-based user equipment (UE) positioning, utilizing machine learning models to improve the accuracy of device location determination. Recognizing the proven benefits of AI-based methods, 3GPP has initiated study items for AI-based use cases in Release-18, anticipating the emergence of novel applications soon. The operation modes for AI in wireless systems are broadly categorized into one-sided and two-sided operations. In one-sided operation, an AI model is independently deployed either at the base station (BS) or the user equipment (UE), exemplified by CSI prediction. Conversely, in two-sided operation, a pair of AI models collaboratively execute an operation, with one deployed at the BS and its counterpart at the UE, as seen in the case of CSI compression. This dual approach underscores the versatility of AI in optimizing wireless communication through both independent and cooperative deployment scenarios, further solidifying its pivotal role in shaping the future of wireless systems.

The deployment and utilization of AI models in wireless systems involve strategic considerations to optimize performance and overcome limitations. Once AI models are trained, their presence on the device, whether it be user equipment (UE) or base station (BS), is essential for executing AI-based operations. In scenarios, such as CSI compression or prediction, where real-time decision-making is crucial, the trained models need to reside on the UE. This configuration helps reduce latency in AI-based operations, particularly when dealing with smaller-sized AI models. However, the challenge arises from the limited memory capacity of UEs, making it impractical to store a wide range of AI models. To address this, the 3rd generation partnership project (3GPP) has proposed, in the context of Release-18, that UEs should either store AI models or have the capability to download them from the BS.

The decision to store AI models on the UE or download them from the BS hinges on several factors. Storing models on the BS is a feasible approach due to its higher computation power and greater memory storage compared to UEs. The BS, having access to diverse data and substantial computational resources, may efficiently train AI models, accounting for dynamic field scenarios. This centralized approach ensures that the BS maintains the latest and most optimized AI models. On the other hand, UEs, with limited computational capabilities and memory, benefit from the ability to download models from the BS. This allows UEs to access up-to-date AI models tailored to evolving wireless conditions, resulting in improved gains and overall system efficiency.

However, for successful model download, certain pre-requisites must be met. The UE needs to possess the capability to execute AI-based operations, ensuring it may effectively utilize the downloaded models. Additionally, the UE should be equipped to download AI models from the BS, establishing a seamless communication channel between the two entities. Lastly, the UE should be capable of configuring the AI models as per the instructions received from the BS, ensuring alignment with the network's operational requirements. These pre-requisites collectively form the foundation for a robust and efficient deployment of AI models in wireless systems, striking a balance between computational efficiency and real-time adaptability.

Now the capability for UE to download AI models in wireless systems brings forth a host of advantages, contributing to enhanced performance and adaptability. This feature is particularly crucial in scenarios where the UE needs to execute a diverse range of AI-based operations. By allowing UEs to download the latest AI models, the system benefits from improved efficiency and optimized decision-making. In the context of Release-18, many companies participating in the study have emphasized the added advantage of enabling the UE to possess the capability to download AI models. This capability ensures that UEs stay abreast of advancements and evolving requirements, ultimately leading to better overall system performance.

The procedural operations involved in AI model download have been illustrated in an embodiment of this disclosure which highlights a systematic approach to facilitate seamless communication between the base station (gNB) and the UE. The gNB, responsible for loading stored AI models, initiates the process by soliciting crucial information from the UE. This includes the UE's capability to support AI operations, such as the execution of AI-based tasks like channel state information (CSI) compression, and the UE's capability to download new AI models. Once the UE shares its capability information, the gNB responds by providing AI execution information (AEI) along with CSI report configuration information (CSIReportConfig) to the UE. The AEI contains crucial details on how to configure and utilize the AI model effectively.

The subsequent operations involve the actual transfer of the AI model from the BS to the UE. Once received, the UE configures the model in accordance with the provided AEI. This operation is pivotal in ensuring that the AI model aligns with the specific requirements and operational parameters of the network. With the AI model successfully configured, the UE may seamlessly perform AI-based operations, utilizing the downloaded model to make informed decisions. The outcome of these operations is subsequently shared with the BS, completing the feedback loop. This entire process underlines the importance of AI model download in empowering UEs with the latest capabilities, fostering adaptability, and maximizing the efficiency of wireless systems.

The challenge posed by the need to transfer multiple similar AI models for similar operations, especially in scenarios like handovers or carrier aggregation (CA), underscores the inherent inefficiencies in the current process. Consider the example of a handover where the UE switches from one gNB (gNB1) to another (gNB2). If gNB1 and gNB2 support different reporting periodicities, the UE, having initially downloaded AI models from gNB1, now needs to download new models from gNB2 to accommodate the changed reporting periodicity. This necessitates the UE to reconfigure the AI model for its usage, leading to inefficiencies and potential disruptions in connectivity.

The inefficiency becomes even more apparent in scenarios like carrier aggregation (CA), where multiple component carriers (CCs) may require similar models to be downloaded and configured. This repetitive process of downloading and configuring similar models for different configurations not only consumes precious bandwidth but also introduces unnecessary complexity into the system. Addressing this challenge is crucial for maintaining seamless connectivity during configuration changes and ensuring that AI-based operations may adapt to varying network conditions efficiently.

To overcome these inefficiencies, there is a clear need for an intelligent and efficient approach to handling AI model downloads. One potential solution lies in exploiting the similarity factor between models of various configurations i.e., rather than downloading entirely new models for each configuration change, a more streamlined approach could involve identifying commonalities among models and selectively transferring only the differentiating components. This could significantly reduce the bandwidth requirements and speed up the reconfiguration process, ultimately leading to a more optimized and responsive AI model management system in wireless networks. Implementing such intelligent strategies is essential for unlocking the full potential of AI in wireless systems while mitigating the challenges associated with frequent configuration changes.

The information disclosed in this background of the disclosure section is only for enhancement of understanding of the general background of the disclosure and should not be taken as an acknowledgement or any form of suggestion that this information forms the prior art already known to a person skilled in the art.

In an embodiment of the disclosure, a representation of a sample sequence of events that is expected to take place in a typical distributed computing network deployment. In recent times, distributed computing is gaining vast attention from researchers and developers where computation may be done on multiple devices, as execution is distributed over devices, artificial intelligence (AI) application developers have to predefine or hardcode the send receive format of AI data. As AI applications handle more scenarios, such as distributed computing, federated learning, split federated learning, or the like, it becomes complicated to manage these tasks. For example, in a split computing environment, machine learning model execution is distributed among two or more computationally capable devices. In a typical scenario, some part of the execution happens on one device and the rest on another.

Further, there is no agreed communication format between the devices on execution environment of tensor data for different scenarios. For Example, in an embodiment of the disclosure, the receiving device does not have any information regarding the number of layers to execute, kind of data to process, type of model to use, dimension of data, or the like.

A representation of procedural flow (regarding tensor data) according to one of the embodiments is enclosed which proposes a solution for the first use case for split computing / distributed computing networks. As illustrated, the sending device executes CNN layers from 1 to K out of N layers and sends execution environment and tensor data using the tensor data protocol to another device to run K+1 to N layers. Receiving device reads tensor data headers, to know about the tensor data, like dimension of a tensor data, CNN layers executed at sending device, quantized data or float data, quantization type, differential encoded data or not, or the like. Upon loading the appropriate model which matches to tensor data headers the receiving device executes from K+1 layers to N layers of a CNN model.

In an embodiment of the disclosure, a representation of tensor data protocol and tensor metadata description according to one of the embodiments is enclosed. The tensor data protocol parameter comprises a plurality of parameters such as, Header field, tensor data field, tensor processor, tensor model, or the like.

In an embodiment a representation of tensor data protocol as an application protocol for data communication between sender and receiver according to one of the embodiments is enclosed. The tensor data protocol has protocol headers, tensor codec (encoder / decoder), optimized methods specific to tensor data like simultaneous encoding and sending / simultaneous receiving and decoding. It is a futuristic protocol suits for tensor streaming data.

In an embodiment of the disclosure, a flow representation of tensor data protocol as an application protocol for data communication between sender and receiver according to one of the embodiments is enclosed. In the case of distributed computing, at sending side, a partial inference model is executed at the sender and tensor data is transferred to the receiver (cloud, edge cloud, server, device, or the like) using a tensor data protocol. Tensor Metadata description has been set before sending the tensor data.

At the receiver side, a tensor data protocol instance created in receiver mode (subscribed to receive a tensor data Listening on some standard port to receive tensor requests) and waiting for tensor requests, tensor metadata description is received and read and prior receiving tensor data. Upon receiving a request, receiver device reads tensor headers.

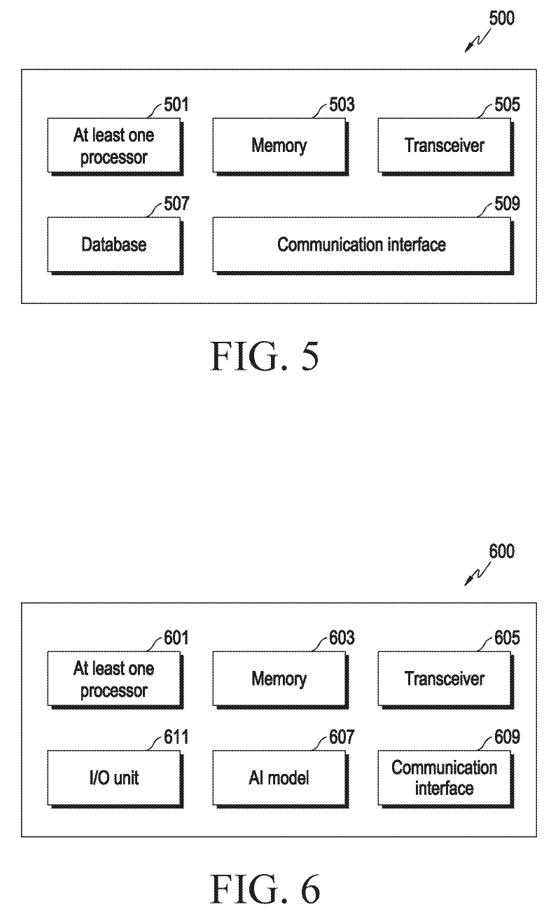

In an embodiment of the disclosure, are representations of procedural flow of sequence which exchange tensor specific information (signaling and response) according to one of the embodiments is enclosed. FIG. 6 depicts the process of tensor signaling. The tensor signaling may be over any generic like JSON, XML, Text parsing or protocols like SDP, SIP or any other signaling protocols. Any transport protocol may be used to send this negotiation information.

The terminologies may include the following:

Sender wants to send "FLOAT" tensor data

Sender wants to send 3D FLOAT tensor data with shape [3][4][5]

Content type: partial inference (PI) / forward propagation (FP) / back propagation (BP) / full inference (FI)

Data type: differential codec used (DIFF) or not (FULL)

Tensor codec: Codecs designed especially for tensor data or any other efficient codec used for tensor data reduction.

Transport protocol supported to send the tensor data. Port to contact the Sender

Tensor compression: Tensor compressions supported by sender (Brotli, z-standard, DEFLATE, or the like)

As illustrated, the process of tensor signaling response may be include:

Tensor data receiver listening on a specified standard port (Like HTTP port 80, MQTT port 1883, or the like)

Accepts the signaling request and reply the signaling parameters.

Receiver refers CNN model on which "ContentType" action is required

Sender picks the protocol, port mentioned in signaling and connect to Receiver and starts sending the tensor data.

Receiver picks the tensor data and refer to signaling parameters. And invoke a appropriate action based on content type.

A representation spilt computing/distributed computing using session based negotiation according to one of the embodiments is enclosed. Wherein, the sending device executes k layers and sends the partial inference data over network to AI service modules present in cloud/edge.

A representation of procedural tensor specific information flow using control message in distributed computing according to one of the embodiments is enclosed. As illustrated the sending device sends tensor metadata description to the receiver, upon which the receiver generates the answer for a partial inference content type.

A representation of tensor headers during procedural tensor specific information flow using control message in distributed computing according to one of the embodiments is enclosed. The tensor specific information may include various fields, such as tensor header, payload length, and payload. Accordingly, the AI modules being loaded with reference to the "ContentType".

A representation of procedural flow of sequence in federated learning which exchange tensor specific information (signaling and response) according to one of the embodiments is enclosed. Wherein, multiple decentralized edge devices or servers holding local data samples, are being trained without exchanging the training algorithm.

A representation of procedural tensor specific information flow (signaling and response) using control message in federated learning according to one of the embodiments is enclosed. In case of federated learning as well as client updating to federated server, at sending side, a partial inference model is executed at the sender and tensor data transferred as well to receiver (cloud, edge cloud, server, device, or the like) using a tensor data protocol. Tensor metadata description has been set before sending the tensor data.

At receiver side, a tensor data protocol instance created in receiver mode (subscribed to receive a tensor data Listening on some standard port to receive tensor requests) and waiting for tensor requests, tensor metadata description is received and read and prior receiving tensor data. Upon receiving a request, receiver device reads tensor headers.

A representation of tensor headers during procedural tensor specific information flow using control message in federated learning according to one of the embodiments is enclosed. The tensor specific information may include various fields, such as tensor header, payload length, and payload. Accordingly, the AI modules being loaded with reference to the "ContentType".

A representation of procedural tensor specific information flow (signaling and response) using control message in split federated learning according to one of the embodiments is enclosed. This illustrates backbone propagation model in case of split federated learning, wherein the back propagation data would be transferred back to the clients.

A representation of procedural tensor specific information flow (signaling and response) using control message in split federated learning according to one of the embodiments is enclosed.

A representation of tensor headers during procedural tensor specific information flow using control message in split federated learning according to one of the embodiments is enclosed.

A representation of procedural error flow according to one of the embodiments is enclosed. This illustrates the scenario, wherein the tensor receiver couldn't handle the request, it would through the appropriate error as following:

400: bad request

403: Forbidden

404: Not found

408 Request time out

500: Internal server error

501 Not implemented

503 Service unavailable, or the like.

A representation of tensor data protocol for dynamic enabling / disabling of tensor codec feature in distributed computing network according to one of the embodiments is enclosed. If the encoder which is in progress does not give the good results, the protocol automatically turns off the AI data codecs by the claimed disclosure, as illustrated in the embodiment.

A representation of tensor data protocol for dynamically re-negotiating a tensor parameter in data communication network according to one of the embodiments is enclosed. In the scenario, wherein the sender changes the tensor signaling during tensor data which is in progress, the tensor metadata description is being renegotiated again.

In an embodiment of the disclosure, representations of tensor data header according to one of the embodiments are enclosed. As illustrated in the embodiment of the disclosure, the tensor data comprises the following filed:

Header fields: Headers are required during initial setup of a tensor session, if this bit is set to 1 means packet contains a header parameter and payload, if this bit is set to 0 packet contains only tensor payload.

In between session, if any tensor environment changed, say layers executed at client is changed, this field is set to 01, receiver should read updated header and prepare the execution environment according to the tensor headers.

Output content: These fields indicate, final inference data type it may receive from the device-2.

Dimension: Dimension of a tensor data, so that receiving side may convert the data to appropriate dimension.

Content type- It tells the tensor data present in protocol is of what type.

In case of split computing, data content could be "partial inference". In AI use cases, model file may be shared between devices, in this case data content could be "Model file data". In case of federated learning, data content could be "weights" of a local model sent to update the global model. This may be initiated from the cloud to update the global trained model's "weights" to local model.

In case of split federated learning, data content could be "back propagation" model to adjust the weights of local model. Any kind of tensor content may be specified using "tensor-content header.

In an embodiment of the disclosure, a representation of tensor protocol data for distributed computing network according to one of the embodiments is enclosed.

In an embodiment of the disclosure, a representation of tensor protocol data for federated learning network according to one of the embodiments enclosed.

In an embodiment of the disclosure, a representation of updating the weights & biases of Local model by implementing tensor protocol for federated learning network according to one of the embodiments enclosed.

There needs a mechanism to find a common capability of devices which are specific to tensor data for efficient data communication. Like common tensor codec, avoids lot of unnecessary data being transferred over network.

Universal protocol to communicate all kind of AI/ML tensor data between devices.

Standardizing the protocol helps unified communication of AI data irrespective of the vendor solutions.

Single applications may create many instances of tensor and use them for different AI activities.

Tensor data protocol is programming languages agnostic.

Tensor data protocol is platform agnostic Ex: device-1 could be in android and device-2 could be in Linux

All AI services (wherever services present cloud, edge, or the like) may be accessible using tensor data protocol, clients who are complaint to tensor data protocol may leverage.

Timestamp for tensor data helps in calculating round trip time (RTT), packet drops congestions, or the like, depending on this info tensor applications may take appropriate action.

It should be appreciated that the blocks in each flowchart and combinations of the flowcharts may be performed by one or more computer programs which include computer-executable instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g., a central processing unit (CPU)), a communication processor (CP, e.g., a modem), a graphical processing unit (GPU), a neural processing unit (NPU) (e.g., an artificial intelligence (AI) chip), a wireless-fidelity (Wi-Fi) chip, a Bluetooth^{TM} chip, a global positioning system (GPS) chip, a near field communication (NFC) chip, connectivity chips, a sensor controller, a touch controller, a finger-print sensor controller, a display drive integrated circuit (IC), an audio CODEC chip, a universal serial bus (USB) controller, a camera controller, an image processing IC, a microprocessor unit (MPU), a system on chip (SoC), an IC, or the like.

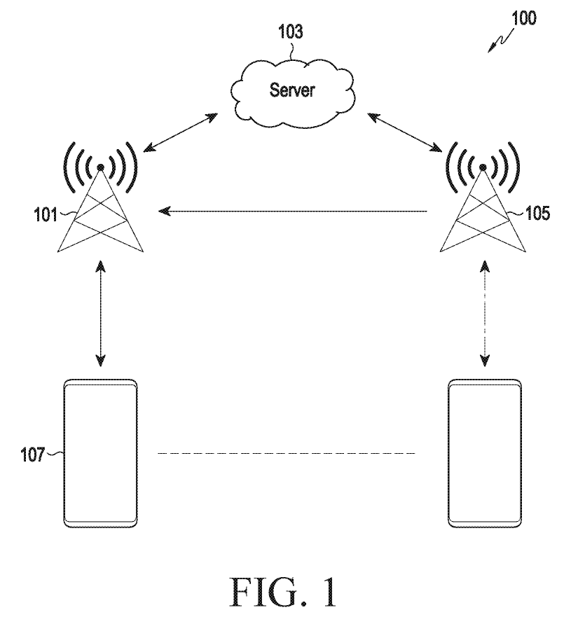

FIG. 1 illustrates an environment for sharing artificial intelligence (AI) models according to an embodiment of the disclosure.

Referring to FIG. 1, an environment 100 may include a target base station 101, a server 103, a serving base station 105 and a user equipment (UE) 107.

In an embodiment of the disclosure, the UE 107 may be configured to connect to the serving base station 105 and establish a communication link for transmitting and receiving data. Furthermore, the UE 107 may also be configured to receive one or more sub-blocks from the serving base station 105. The one or more sub-blocks may include common sub-blocks and/or configuration-specific sub-blocks. Moreover, in the case of a handover, the UE 107 may also be configured to connect to the target base station 101 and establish a communication link for transmitting and receiving data with the target base station. The UE 107 may also be configured to receive one or more AI configuration-specific sub-blocks from the target base station 101. The receiving of the one more sub-blocks by the UE 107 from the serving base station 105 and the target base station 101 is discussed in the embodiments below.

The UE 107 may also be configured to utilize the one or more AI models for one or more functions related to optimizing network performance, enhancing communication efficiency, or supporting other advanced features within the UE 107. However, the application of one or more AI models is not confined to the aforementioned explanation and any other application of AI models is well within the scope of this disclosure.

The target base station 101 may be configured to receive UE capability information from the UE 107 after a handover from the serving base station 105. Further, the target base station 101 may also be configured to receive a previous UE configuration from the serving base station 105. The target base station 101 may be configured to transmit one or more AI configuration-specific sub-blocks along with CSIReportConfig to the UE 107. The sharing of the one or more AI configuration-specific sub-blocks by the target base station 101 is discussed in the embodiments below.

The server 103 may be configured to split the one or more AI models into one or more sub-blocks. Further, the server 103 may also be configured to categorize and store one or more sub-blocks. The categorization of the one or more sub-blocks is discussed in the embodiments below. Furthermore, the server 103 may also be configured to receive a request for one or more sub-blocks from a base-station and transmit the requested one or more sub-blocks to the base-station.

The serving base station 105 may be configured to receive UE capability information from the UE 107. The serving base station 101 may be configured to transmit one or more blocks along with CSIReportConfig to the UE 107. The sharing of the one or more blocks by the serving base station 105 is discussed in the embodiments below.

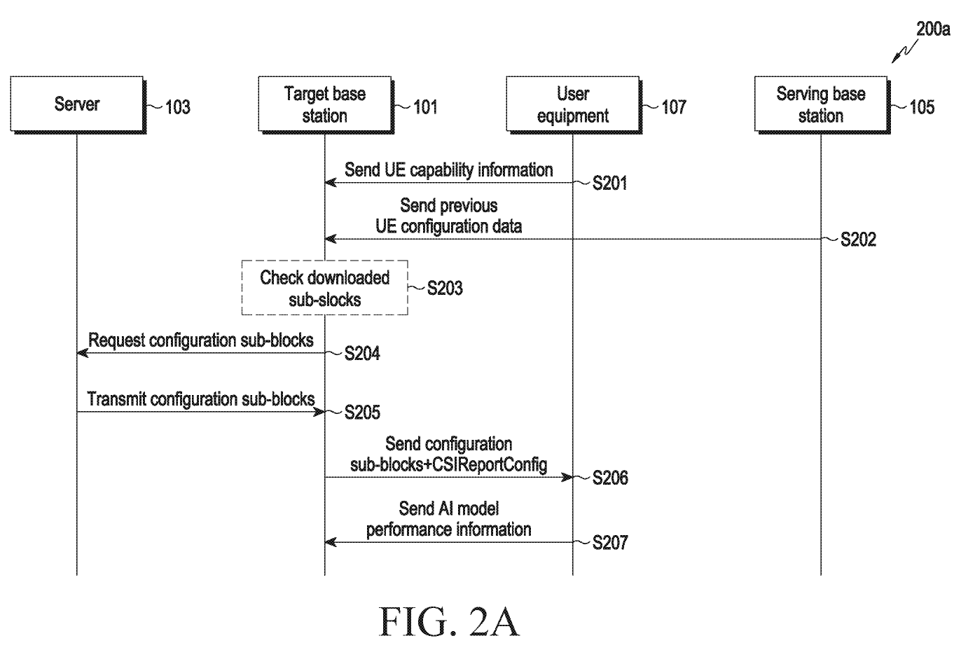

FIG. 2A illustrates a signaling diagram 200a for sharing artificial intelligence (AI) models, according to an embodiment of the disclosure.

Referring to FIG. 2A, the UE 107 may connect to the target base station 101 after a handover from the serving base station 105. Upon connecting to the target base station 101, the UE 107 may transmit UE capability information to the target base station 101 (at operation S201). The UE capability information may be crucial for the target base station 101 to understand the UE's technical specifications, ensuring that the target base station 101 may optimize the communication with the UE 107 based on its capabilities.

Further, the serving base station 105 may also transmit the previous UE configuration data to the target base station 101 (at operation S202). The UE configuration helps the target base station 101 understand how the UE 107 was previously configured.

Thereafter, (at operation S203) the target base station 101 may determine the one or more configuration-specific sub-blocks that may need to be shared with the UE 107 to ensure optimized communication and functioning of the UE 107. Based on this determination, the target base station 101 may request the server 103 to share one or more configuration-specific sub blocks with the target base station 101 (at operation S204). In response to this request, the server 103 may transmit the one or more configuration-specific sub-blocks to the target base station 101 (at operation S205).

Once the target base station 101 downloads the one or more configuration-specific sub-blocks from the server 103, the target base station may transmit the one or more configuration-specific sub-blocks to the UE 107. For this purpose, the target base station 101 may transmit the one or more configuration specific sub-blocks along with CSIReportConfig to the UE (at operation S206). The transmission of the one or more configuration specific sub-blocks is discussed in the embodiments below.

Lastly, the UE 107 may share the AI model performance information with the target base station based on the functioning of the AI model at the UE 107 (at operation S207). The transmitting of the AI model performance information is discussed in the embodiments below.

FIG. 2B illustrates a signaling diagram 200b for loading common sub-blocks and configuration-specific sub-blocks of artificial intelligence (AI) models, in according to an embodiment of the disclosure.

Referring to FIG. 2B, the UE 107 may connect to the serving base station 105 in order to access the communication network. Upon connecting to the serving base station 105, the UE 107 may transmit UE capability information to the serving base station 105 (at operation S208). The UE capability information may include one or more AI based operations supported by the UE 107 and one or more AI model download capability. The UE capability information may be crucial for the serving base station 105 to understand the UE's technical specifications, ensuring that the serving base station 105 may optimize the communication with the UE 107 based on its capabilities.

Thereafter, the serving base station 105 may determine the one or more sub-blocks that may need to be shared with the UE 107 to enable the UE 107 to perform one or more AI based operations. The one or more sub-blocks may include common sub-blocks and configuration-specific sub-blocks. Based on this determination, the serving base station 105 may request the server 103 to share one or more sub-blocks with the serving base station 105. In response to this request, the server 103 may transmit the one or more configuration-specific sub-blocks to the serving base station 105.

Once the serving base station 105 downloads the one or more sub-blocks from the server 103, the serving base station 105 may transmit the one or more sub-blocks to the UE 107. For this purpose, the serving base station 105 may transmit the one or more sub-blocks along with CSIReportConfig to the UE (at operation S209). The common sub-blocks will be shared only once with the UE 107. Further, the CSIReportConfig may also include AI execution information. The AI execution information specifically includes a unique identifier for each block in the AI model, consisting of a block number and block ID. The block ID determines the execution flow of the blocks, while the block number uniquely identifies each block across different AI models. The AI execution information may be stored and shared along with the CSIReportConfig to enable reconfiguration and handover processes.

Once the UE 107 receives the one or more sub-blocks, the UE may load the one or more sub-blocks and configure the one or more AI models based on the AI execution information (at operation S210). Once the AI models are configured, the UE 107 may perform one or more AI based operations (at operation S211).

While the one or more AI based operations may be performed by the UE 107, the UE 107 may measure performance parameters of the AI model based on outputs generated by the AI model. Further, the UE 107 may transmit performance information of the AI model to the serving base station 105 (at operation S212). The performance information may include the performance parameters of the AI model.

In the case where the UE 107 is preparing for a handover, the UE 107 may send an RRC measurement to the serving base station 105 (at operation S213). Thereafter, the serving base station 105 may send a message to the UE 107 regarding the handover to the target base station 101 (at operation S214).

Upon connecting to the target base station 101, the UE 107 may transmit UE capability information to the target base station 101 (at operation S215). The UE capability information may be crucial for the target base station 101 to understand the UE's technical specifications, ensuring that the target base station 101 may share one or more sub-blocks with the UE 107 based on its capabilities.

Further, the serving base station 105 may also transmit the previous UE configuration data to the target base station 101 (at operation S216). The previous UE configuration helps the target base station 101 understand how the UE 107 was previously configured. The target base station 101 may share one or more sub-blocks with the UE 107 based on the UE capability information and the previous UE configuration as discussed in the embodiments below.

FIG. 2C illustrates a signaling diagram 200c for sharing configuration-specific sub-blocks of artificial intelligence (AI) models, according to an embodiment of the disclosure.

Referring to FIG. 2C, the UE 107 may connect to the target base station 101 after a handover from the serving base station 105. Upon connecting to the target base station 101, the UE 107 may transmit UE capability information to the target base station 101 (at operation S217). The UE capability information at least includes one or more AI based operations supported by the UE 107 and one or more AI model download capability. Further, the UE capability information may be crucial for the target base station 101 to understand the UE's technical specifications, ensuring that the target base station 101 may optimize the communication with the UE 107 based on its capabilities.

Further, the target base station 101 may also receive the previous UE configuration data from the serving base station 105. The previous UE configuration data may include a set of configuration parameters of the UE 107 while being connected to the serving base station 105. Further, the previous UE configuration data may include information about the set of AI sub-blocks that were shared with the UE 107 by the serving base station. Therefore, the UE configuration helps the target base station 101 understand how the UE 107 was previously configured.

Thereafter, the target base station 101 may determine one or more sub-blocks that may need to be shared with the UE 107 to ensure optimized communication and functioning of the UE 107 (at operation S218). Since the common sub-blocks have already been shared with the UE 107 by the serving base station 105, the common sub-blocks will not be re-shared by the target base station 101 with the UE 107.

Therefore, the target base station 101 may request the server 103 to share only the one or more configuration-specific sub blocks with the target base station 101. In response to this request, the server 103 may transmit the one or more configuration-specific sub-blocks to the target base station 101.

Once the target base station 101 downloads the one or more configuration-specific sub-blocks from the server 103, the target base station may transmit the one or more configuration-specific sub-blocks to the UE 107. For this purpose, the target base station 101 may transmit the one or more configuration specific sub-blocks along with CSIReportConfig to the UE (at operation S219). Further, the CSIReportConfig may also include AI execution information. The AI execution information specifically includes a unique identifier for each block in the AI model, consisting of a block number and block ID. The block ID determines the execution flow of the blocks, while the block number uniquely identifies each block across different AI models. The AI execution information may be stored and shared along with the CSIReportConfig to enable reconfiguration and handover processes.

Once the UE 107 receives the one or more sub-blocks, the UE may load the one or more sub-blocks and configure the one or more AI models based on the AI execution information (at operation S220). Once the AI models are configured, the UE 107 may perform one or more AI based operations (at operation S221).

While the one or more AI based operations may be performed by the UE 107, the UE 107 may measure performance parameters of the AI model based on outputs generated by the AI model. Further, the UE 107 may transmit performance information of the AI model to the target base station 101 (at operation S222). The performance information may include the performance parameters of the AI model.

Lastly, the UE 107 may share the AI model performance information with the target base station based on the functioning of the AI model at the UE 107. The sharing of the AI model performance information is discussed in the embodiments below.

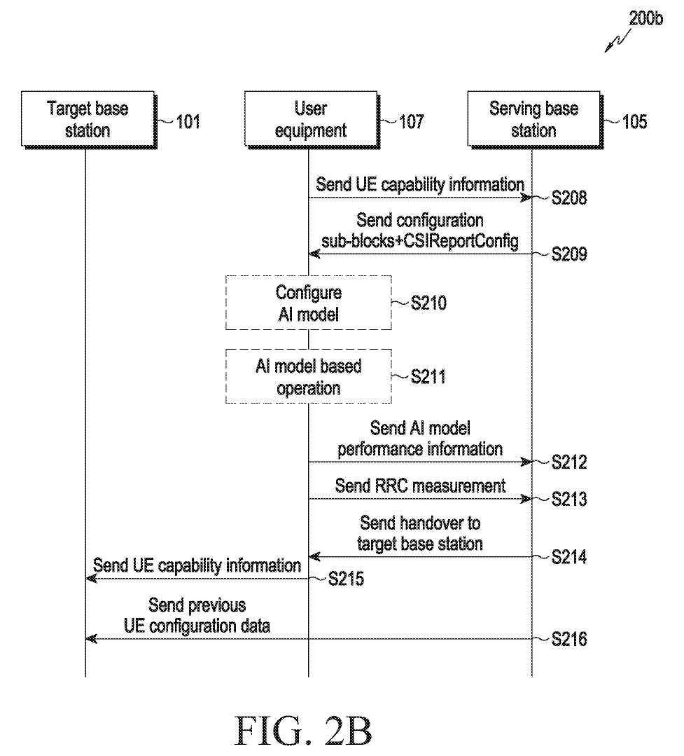

FIG. 3 illustrates an embodiment of splitting of one or more artificial intelligence (AI) configuration blocks of AI models according to an embodiment of the disclosure.

Referring to FIG. 3, AI models, such as encoder-decoder architectures, consist of multiple layers that may be grouped into sub-blocks. As illustrated in FIG. 3, an example encoder-decoder model may comprise three layers in both the encoder and decoder blocks. The server of the disclosure may group the layers into sub-blocks for more efficient execution and reconfiguration. Each sub-block, may be identified by a unique block ID. Further, each sub-block may be designed to perform a specific task or serve multiple tasks depending on the configuration. For instance, in the example shown in FIG. 3, the input layers of the encoder are grouped together in sub-block 301, the output layer is placed in sub-block 303, and the entire layers of the decoder are grouped in sub-block 305.

Further, according to an embodiment of the disclosure, the sub-blocks may be classified as common and configuration-specific blocks. The classification of sub-blocks into common and configuration-specific blocks may be based on certain criteria.

For example, as shown in FIG. 3, sub-block 301 (input block) is independent of the configuration, but dependent on the input given to it. On the other hand, sub-blocks 303 and 305 are configuration-dependent but independent of the input as long as sub-block 301 is fixed. Thus, when the input remains fixed but the configuration changes, sub-block 301 may be reused, while sub-blocks 303 and 305 may be adapted according to the new configuration. Conversely, when the input changes but the configuration remains the same, sub-blocks 303 and 305 may be reused, and sub-block 301 may be adjusted based on the new input. Therefore, assuming that the input remains fixed, sub-block 301 may be designated as a common sub-block, while sub-blocks 303 and 305 may be configuration-specific sub-blocks.

This classification significantly enhances the efficiency of AI model reconfiguration, reducing redundant computations and optimizing resource utilization in dynamic environments. The reuse of sub-blocks, depending on the input or configuration, facilitates faster processing and easier adaptation to varying network conditions or task requirements.

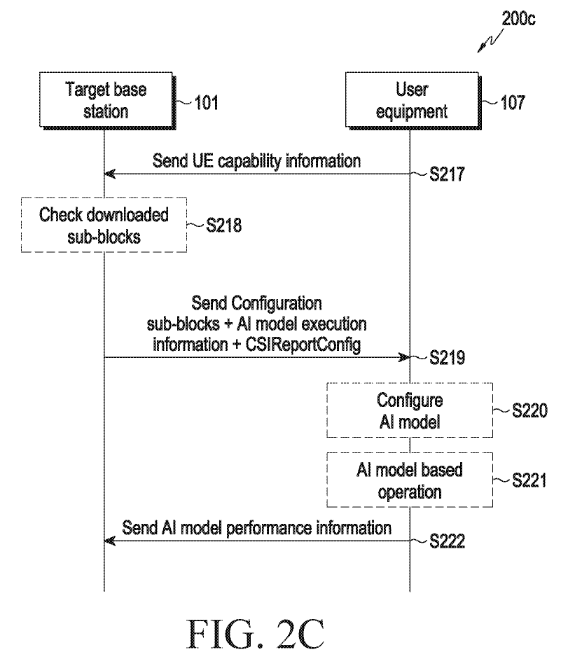

FIG. 4 illustrates a block diagram of a base station for sharing artificial intelligence (AI) models according to an embodiment of the disclosure.

Referring to FIG. 4, in an embodiment of the disclosure, a base station 400 may comprise memory 403, at least one processor 401, a database 407 and a transceiver 405 communicatively coupled with each other. In one non-limiting embodiment of the disclosure, the base station 400 may also comprise a communication interface.

In one embodiment of the disclosure, the transceiver 405 may be configured to send to receive data from a user equipment and server. Further, the database 407 may be configured to store one or more AI model sub-blocks.

It may be noted that, in some embodiments of the disclosure, the base station 400 may include more or fewer components than those depicted herein. The various components of the base station 400 may be implemented using hardware, software, firmware or any combinations thereof. Further, the various components of the base station 400 may be operably coupled with each other. More specifically, various components of the base station 400 may be capable of communicating with each other using communication channel media (such as buses, interconnects, or the like).

In one embodiment of the disclosure, the at least one processor 401 may be embodied as a multi-core processor, a single core processor, or a combination of one or more multi-core processors and one or more single core processors. For example, the at least one processor 401 may be embodied as one or more of various processing devices, such as a coprocessor, a microprocessor, a controller, a digital signal processor (DSP), a processing circuitry with or without an accompanying DSP, or various other processing devices including, a microcontroller unit (MCU), a hardware accelerator, a special-purpose computer chip, or the like.

The processor 401 may include one or a plurality of processors. At this time, one or a plurality of processors may be a general-purpose processor, such as a central processing unit (CPU), an application processor (AP), or the like, a graphics-only processing unit, such as a graphics processing unit (GPU), a visual processing unit (VPU), and/or an AI-dedicated processor, such as a neural processing unit (NPU).

In one embodiment of the disclosure, the memory 403 is capable of storing machine executable instructions, referred to herein as instructions. In an embodiment of the disclosure, the at least one processor 401 is embodied as an executor of software instructions. As such, the at least one processor 401 is capable of executing the instructions stored in the memory 403 to perform one or more operations described herein.

The memory 403 may be any type of storage accessible to the at least one processor 401 to perform respective functionalities and instructions stored in the memory 403. For example, the memory 403 may include one or more volatile or non-volatile memories, or a combination thereof. For example, the memory 403 may be embodied as semiconductor memories, such as flash memory, mask read only memory (ROM), programmable ROM (PROM), erasable PROM (EPROM), random access memory (RAM), or the like.

In one embodiment of the disclosure, the at least one processor 401 may be configured to receive UE capability information from a UE. The UE capability information may be received once the UE connects to the base station 400 after a handover from a serving base station. The UE capability information may include one or more AI based operations supported by the UE and one or more AI model download capability. Further, the at least one processor 401 may also be configured to receive previous UE configuration data from the serving base station. The previous UE configuration data may help the base station 400 understand how the UE was previously configured. The base station 400 may share one or more AI configuration specific sub-blocks with the UE based on the UE capability information and the previous UE configuration

Thereafter, the at least one processor 401 may be configured to determine the one or more sub-blocks corresponding to at least one AI model that may need to be shared with the UE to enable the UE to perform one or more AI based operations. The one or more sub-blocks corresponding to at least one AI model may include one or more configuration-specific sub-blocks. Based on this determination, the at least one processor 401 may be configured to download from a server, the one or more configuration specific sub-blocks corresponding to at least one AI model at least based on the previous UE configuration data and the UE capability information. Furthermore, the at least one processor 401 may be configured to download from the server, the one or more configuration specific sub-blocks corresponding to the at least one AI model based on AI operations supported by the target base station.

Once the one or more configuration specific sub-blocks have been received from the server, the at least one processor 401 may be configured to transmit the one or more sub-blocks to the UE. Since the common sub-blocks will be shared only once with the UE by the serving base station, the at least one processor 401 is configured to transmit only the configuration specific sub-block to the UE. For this purpose, the at least one processor 401 may be configured to transmit the one or more AI configuration specific sub-blocks along with CSIReportConfig to the UE. Further, the CSIReportConfig may also include AI execution information. The AI execution information specifically includes a unique identifier for each block in the AI model, consisting of a block number and block ID. The block ID determines the execution flow of the blocks, while the block number uniquely identifies each block across different AI models. The AI execution information may be stored and shared along with the CSIReportConfig to enable reconfiguration and handover processes.

Once the UE receives the one or more AI configuration specific sub-blocks from the base station 400, the UE may perform one or more AI based operations. Lastly, the at least one processor 401 may be configured to receive performance information of the at least one AI model. The performance information may include the performance parameters of the AI model.

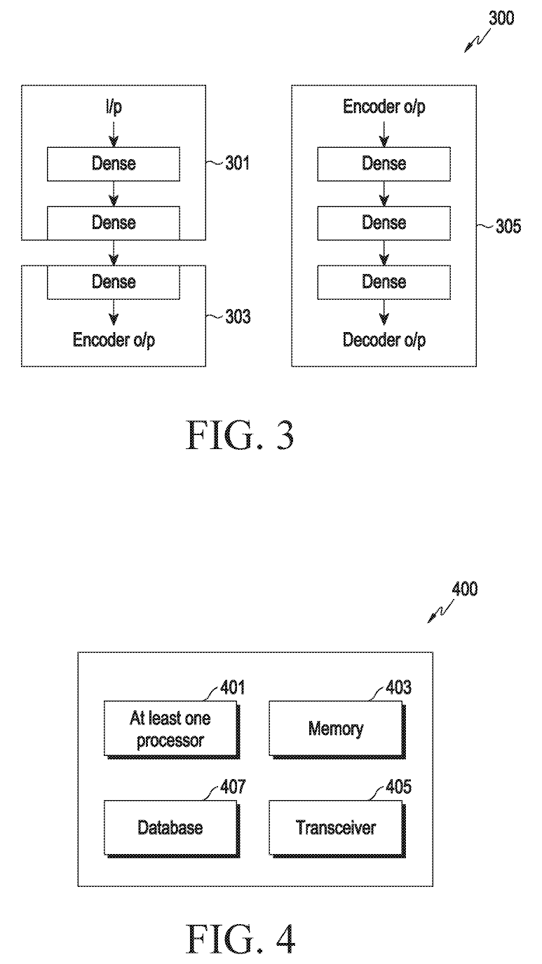

FIG. 5 illustrates a block diagram of a server for managing artificial intelligence (AI) models according to an embodiment of the disclosure.

Referring to FIG. 5, in an embodiment of the disclosure, a server 500 may comprise memory 503, at least one processor 501, a database 507 and a transceiver 505 and a communication interface 509 communicatively coupled with each other.

In one embodiment of the disclosure, the transceiver 505 may be configured to send to receive data from a base station. Further, the database 507 may be configured to store one or more AI model sub-blocks.

It may be noted that, in some embodiments of the disclosure, the server 500 may include more or fewer components than those depicted herein. The various components of the server 500 may be implemented using hardware, software, firmware or any combinations thereof. Further, the various components of the server 500 may be operably coupled with each other. More specifically, various components of the server 500 may be capable of communicating with each other using communication channel media (such as buses, interconnects, or the like).

In one embodiment of the disclosure, the at least one processor 501 may be embodied as a multi-core processor, a single core processor, or a combination of one or more multi-core processors and one or more single core processors. For example, the at least one processor 501 may be embodied as one or more of various processing devices, such as a coprocessor, a microprocessor, a controller, a digital signal processor (DSP), a processing circuitry with or without an accompanying DSP, or various other processing devices including, a microcontroller unit (MCU), a hardware accelerator, a special-purpose computer chip, or the like.

The processor 501 may include one or a plurality of processors. At this time, one or a plurality of processors may be a general-purpose processor, such as a central processing unit (CPU), an application processor (AP), or the like, a graphics-only processing unit, such as a graphics processing unit (GPU), a visual processing unit (VPU), and/or an AI-dedicated processor, such as a neural processing unit (NPU).

In one embodiment of the disclosure, the memory 503 is capable of storing machine executable instructions, referred to herein as instructions. In an embodiment of the disclosure, the at least one processor 501 is embodied as an executor of software instructions. As such, the at least one processor 501 is capable of executing the instructions stored in the memory 503 to perform one or more operations described herein.

The memory 503 may be any type of storage accessible to the at least one processor 501 to perform respective functionalities and instructions stored in the memory 503. For example, the memory 503 may include one or more volatile or non-volatile memories, or a combination thereof. For example, the memory 503 may be embodied as semiconductor memories, such as flash memory, mask ROM, , EPROM, RAM, or the like.

In one embodiment of the disclosure, the at least one processor 501 may be configured to split an AI model into a plurality of blocks based on at least one input parameter and at least one configuration parameter. Furthermore, the at least one processor 501 may also be configured to assign a unique identifier to each sub-block of the AI model. The unique identifier may comprise a block number and a block ID. The block ID may be used to determine the flow of execution of the blocks of the AI model and the block number may be used to uniquely identify each of the blocks across various AI models. Further, the identifier information may be stored in AI model execution information and shared along with CSIReportConfig by a base station with a UE.

Furthermore, the at least one processor 501 may also be configured to receive a request for one or more sub-blocks from a base station. The request for one or more sub-blocks may be from a target base station or a serving base station. Therefore, the request from the base station may comprise configuration specific sub-blocks and/or the common sub-blocks.

Lastly, the at least one processor 501 may be configured to transmit the requested one or more sub-blocks to the base-station.

FIG. 6 illustrates a block diagram of a user equipment for loading artificial intelligence (AI) models according to an embodiment of the disclosure.

Referring to FIG. 6, in an embodiment of the disclosure, a user equipment 600 may comprise memory 603, at least one processor 601, at least one AI model 607, a transceiver 605, a communication interface 609 and an input/output (I/O) unit 611 communicatively coupled with each other.

In one embodiment of the disclosure, the transceiver 605 may be configured to send to receive data from a base station. Further, the at least one AI model 607 may be configured to perform one or more AI based operations.

It may be noted that, in some embodiments of the disclosure, the user equipment 600 may include more or fewer components than those depicted herein. The various components of the user equipment 600 may be implemented using hardware, software, firmware or any combinations thereof. Further, the various components of the user equipment 600 may be operably coupled with each other. More specifically, various components of the user equipment 600 may be capable of communicating with each other using communication channel media (such as buses, interconnects, or the like).

In one embodiment of the disclosure, the at least one processor 601 may be embodied as a multi-core processor, a single core processor, or a combination of one or more multi-core processors and one or more single core processors. For example, the at least one processor 601 may be embodied as one or more of various processing devices, such as a coprocessor, a microprocessor, a controller, a digital signal processor (DSP), a processing circuitry with or without an accompanying DSP, or various other processing devices including, a microcontroller unit (MCU), a hardware accelerator, a special-purpose computer chip, or the like.

The processor 601 may include one or a plurality of processors. At this time, one or a plurality of processors may be a general-purpose processor, such as a central processing unit (CPU), an application processor (AP), or the like, a graphics-only processing unit, such as a graphics processing unit (GPU), a visual processing unit (VPU), and/or an AI-dedicated processor, such as a neural processing unit (NPU).

In one embodiment of the disclosure, the memory 603 is capable of storing machine executable instructions, referred to herein as instructions. In an embodiment of the disclosure, the at least one processor 601 is embodied as an executor of software instructions. As such, the at least one processor 601 is capable of executing the instructions stored in the memory 603 to perform one or more operations described herein.

The memory 603 may be any type of storage accessible to the at least one processor 601 to perform respective functionalities and instructions stored in the memory 603. For example, the memory 603 may include one or more volatile or non-volatile memories, or a combination thereof. For example, the memory 603 may be embodied as semiconductor memories, such as flash memory, mask ROM, PROM, EPROM, RAM, or the like.

In one embodiment of the disclosure, the UE 600 may be configured to connect to a base station. In an embodiment of the disclosure, the UE 600 may be configured to connect to a serving base station. in order to access the communication network.

Upon connecting to the serving base station, the at least one processor 601 may be configured to transmit UE capability information to the serving base station. The UE capability information may include one or more AI based operations supported by the UE 600 and one or more AI model download capability. The UE capability information may be crucial for the serving base station to understand the UE's technical specifications, ensuring that the serving base station may optimize the communication with the UE 600 based on its capabilities.

Thereafter, the serving base station may determine the one or more sub-blocks that may need to be shared with the UE 600 to enable the UE 600 to perform one or more AI based operations. The one or more sub-blocks may include common sub-blocks and configuration-specific sub-blocks. Based on this determination, the at least one processor 601 may be configured to receive the one or more common sub-blocks corresponding to an AI model along with the CSIReportConfig. The common sub-blocks will be shared only once with the UE 600. Further, the CSIReportConfig may also include AI execution information. The AI execution information may include data or parameters related to the execution of artificial intelligence (AI) models within the UE 600.

Once the one or more sub-blocks are received, the at least one processor 601 may be configured to configure the one or more AI models based on the AI execution information within the CSIReportConfig. Once the AI models are configured, the UE 107 may perform one or more AI based operations.

In the case where the UE 600 is preparing for a handover, the at least one processor 601 may be configured to send an RRC measurement to the serving base station. Thereafter, the at least one processor 601 may be configured to receive a message from the serving base station regarding the handover to a target base station.

Upon connecting to the target base station, the at least one processor 601 may be configured to transmit UE capability information to the target base station. The UE capability information may be crucial for the target base station to understand the UE's technical specifications, ensuring that the target base station may share one or more sub-blocks with the UE 600 based on its capabilities.

The target base station may determine one or more sub-blocks that may need to be shared with the UE 600 based on the UE capability information and previous UE configuration. Since the common sub-blocks have already been received by the UE 600 from the serving base station, the common sub-blocks will not be re-shared by the target base station with the UE 600.

The target base station may share one or more configuration-specific sub-blocks with the UE 600. For this purpose, the at least one processor 601 may be configured to receive the one or more configuration specific sub-blocks corresponding to an AI model along with CSIReportConfig from the target base station. The CSIReportConfig may at least comprise AI model execution information. The CSIReportConfig may also include AI execution information. The AI execution information specifically includes a unique identifier for each block in the AI model, consisting of a block number and block ID. The block ID determines the execution flow of the blocks, while the block number uniquely identifies each block across different AI models. The AI execution information may be stored and shared along with the CSIReportConfig to enable reconfiguration and handover processes.

Once the one or more sub-blocks have been received, the at least one processor 601 may be configured to configure the one or more AI models based on the one or more configuration specific sub-blocks and the AI model execution information within the CSIReportConfig. Once the AI models are configured, one or more AI based operations may be performed by the UE 600.

While the one or more AI based operations are being performed, the at least one processor 601 may be configured to measure performance parameters of the AI model based on outputs generated by the AI model. Further, the at least one processor 601 may be configured to transmit performance information of the AI model to the target base station. The performance information may include the performance parameters of the AI model.

Lastly, the at least one processor 601 may be configured to share the AI model performance information with the target base station based on the functioning of the AI model at the UE 600.

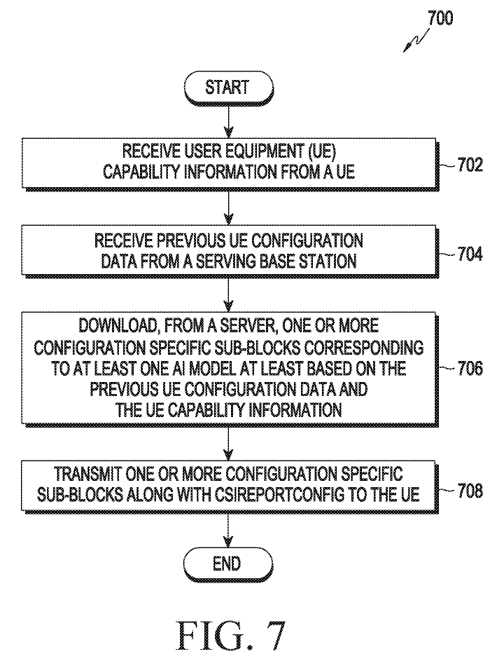

FIG. 7 illustrates a flowchart for a method for sharing artificial intelligence (AI) models by a target base station, according to an embodiment of the disclosure.

Referring to FIG. 7, at operation 702, a method 700 discloses receiving UE capability information from a UE. The UE capability information may be received once the UE connects to the target base station after a handover from a serving base station. The UE capability information may include one or more AI based operations supported by the UE and one or more AI model download capability.

Further, at operation 704, the method 700 discloses receiving previous UE configuration data from the serving base station. The previous UE configuration data may help the target base station understand how the UE was previously configured. The target base station may share one or more AI configuration specific sub-blocks with the UE based on the UE capability information and the previous UE configuration.

Thereafter, the method 700 discloses determining the one or more sub-blocks corresponding to at least one AI model that may need to be shared with the UE to enable the UE to perform one or more AI based operations. The one or more sub-blocks corresponding to at least one AI model may include one or more configuration-specific sub-blocks. Based on this determination, at operation 706, the method 700 discloses downloading the one or more configuration specific sub-blocks corresponding to at least one AI model at least based on the previous UE configuration data and the UE capability information from a server. Furthermore, the method 700 discloses downloading the one or more configuration specific sub-blocks corresponding to the at least one AI model based on AI operations supported by the target base station.

Once the one or more configuration specific sub-blocks have been received from the server, at operation 708, the method 700 discloses transmitting the one or more sub-blocks to the UE. The common sub-blocks will be shared only once with the UE by the serving base station. In the case of the target base station, the method 700 discloses transmitting the configuration specific sub-block to the UE. For this purpose, the method 700 discloses transmitting the one or more AI configuration specific sub-blocks along with CSIReportConfig to the UE. Further, the CSIReportConfig may also include AI execution information. The CSIReportConfig may also include AI execution information. The AI execution information specifically includes a unique identifier (ID) for each block in the AI model, consisting of a block number and a block ID. The block ID determines the execution flow of the blocks, while the block number uniquely identifies each block across different AI models. The AI execution information may be stored and shared along with the CSIReportConfig to enable reconfiguration and handover processes.

Once the UE receives the one or more AI configuration specific sub-blocks from the target base station, the UE may perform one or more AI based operations. Lastly, the method 700 discloses receiving performance information of the at least one AI model. The performance information may include the performance parameters of the AI model.

The sequence of operations of the method 700 need not be necessarily executed in the same order as they are presented. Further, one or more operations may be grouped together and performed in the form of a single operation, or one operation may have several sub-operations that may be performed in parallel or in a sequential manner. Meanwhile, the above-described method 700 performed by the base station 400 may be performed using an artificial intelligence model.

The disclosed method with reference to FIG. 7, or one or more operations of the base station 400 explained with reference to FIG. 4 may be implemented using software including computer-executable instructions stored on one or more computer-readable media (e.g., non-transitory computer-readable media, such as one or more optical media discs, volatile memory components (e.g., DRAM or SRAM), or non-volatile memory or storage components (e.g., hard drives or solid-state non-volatile memory components, such as flash memory components) and executed on a computer (e.g., any suitable computer, such as a laptop computer, net book, Web book, tablet computing device, smart phone, or other mobile computing device). Such software may be executed, for example, on a single local computer.

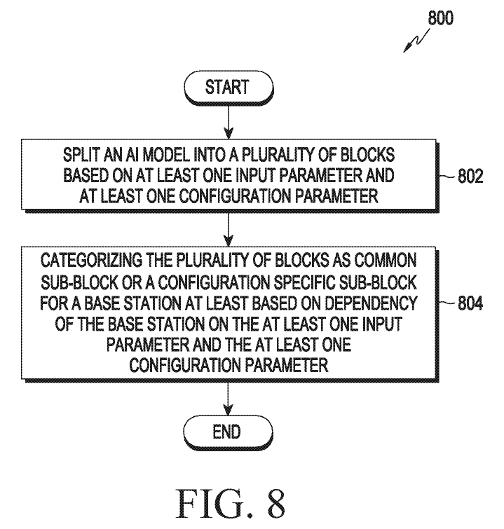

FIG. 8 illustrates a flowchart for a method for managing artificial intelligence (AI) models by a server according to an embodiment of the disclosure.

Referring to FIG. 8, at operation 802, a method 800 discloses splitting an AI model into a plurality of blocks based on at least one input parameter and at least one configuration parameter.

At operation 804, the method 800 discloses categorizing the plurality of blocks as common sub-block or configuration specific sub-block for a base station at least based on dependency of the base station on the at least one input parameter and the at least one configuration parameter.

Furthermore, the method 800 discloses assigning a unique identifier to each sub-block of the AI model. The unique identifier may comprise a block number and a block ID. The block ID may be used to determine the flow of execution of the blocks of the AI model and the block number may be used to uniquely identify each of the blocks across various AI models. Further, the identifier information may be stored in AI model execution information and shared along with CSIReportConfig by a base station with a UE.

Furthermore, the method 800 discloses receiving a request for one or more sub-blocks from a base station. The request for one or more sub-blocks may be from a target base station or a serving base station. Therefore, the request from the base station may comprise configuration specific sub-blocks and/or the common sub-blocks.

Lastly, the method 800 discloses transmitting the requested one or more sub-blocks to the base-station.

The sequence of operations of the method 800 need not be necessarily executed in the same order as they are presented. Further, one or more operations may be grouped together and performed in the form of a single operation, or one operation may have several sub-operations that may be performed in parallel or in a sequential manner. Meanwhile, the above-described method 800 performed by the server 500 may be performed using an artificial intelligence model.

The disclosed method with reference to FIG. 8, or one or more operations of the server 500 explained with reference to FIG. 5 may be implemented using software including computer-executable instructions stored on one or more computer-readable media (e.g., non-transitory computer-readable media, such as one or more optical media discs, volatile memory components (e.g., DRAM or SRAM), or non-volatile memory or storage components (e.g., hard drives or solid-state non-volatile memory components, such as flash memory components) and executed on a computer (e.g., any suitable computer, such as a laptop computer, net book, Web book, tablet computing device, smart phone, or other mobile computing device). Such software may be executed, for example, on a single local computer.

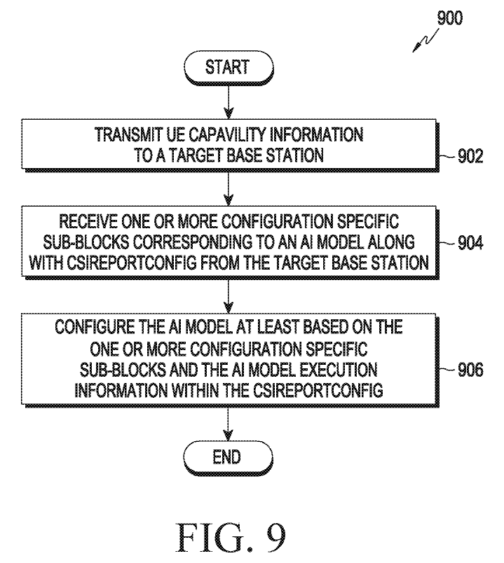

FIG. 9 illustrates a flowchart for a method for loading artificial intelligence (AI) models by a UE according to an embodiment of the disclosure.

Referring to FIG. 9, a method 900 discloses transmitting UE capability information to the serving base station upon a connection being established between a UE and a serving bas station. The UE capability information may include one or more AI based operations supported by the UE and one or more AI model download capability. The UE capability information may be crucial for the serving base station to understand the UE's technical specifications, ensuring that the serving base station may optimize the communication with the UE based on its capabilities.

The serving base station may determine the one or more sub-blocks that may need to be shared with the UE to enable the UE to perform one or more AI based operations. The one or more sub-blocks may include common sub-blocks and configuration-specific sub-blocks. Based on this determination, the method 900 discloses receiving the one or more common sub-blocks corresponding to an AI model along with the CSIReportConfig. The common sub-blocks may be shared only once with the UE. Further, the CSIReportConfig may also include AI execution information.

Once the one or more sub-blocks are received, the method 900 discloses configuring the AI model further based on the one or more common sub-blocks and the AI model execution information. Once the AI models are configured, the UE may perform one or more AI based operations.

In the case where the UE is preparing for a handover, the method 900 discloses sending an RRC measurement to the serving base station. Thereafter, the method 900 discloses receiving a message from the serving base station regarding the handover to a target base station.

Upon connecting to the target base station, the method 900 discloses transmitting UE capability information to the target base station at operation 902. The UE capability information may be crucial for the target base station to understand the UE's technical specifications, ensuring that the target base station may share one or more sub-blocks with the UE based on its capabilities.

The target base station may determine one or more sub-blocks that may need to be shared with the UE based on the UE capability information and previous UE configuration. Since the common sub-blocks have already been received by the UE from the serving base station, the common sub-blocks will not be re-shared by the target base station with the UE.

The target base station may share one or more configuration-specific sub-blocks with the UE. At operation 904, the method 900 discloses receiving the one or more configuration specific sub-blocks corresponding to an AI model along with CSIReportConfig from the target base station. The CSIReportConfig may at least comprise AI model execution information. The CSIReportConfig information may be used by the target base station to optimize the sharing of one or more configuration specific sub-blocks.

Once the one or more sub-blocks have been received, at operation 906, the method 900 discloses configuring the one or more AI models based on the one or more configuration specific sub-blocks and the AI model execution information within the CSIReportConfig. Once the AI models are configured, one or more AI based operations may be performed by the UE.

While the one or more AI based operations are being performed, the method 900 discloses measuring performance parameters of the AI model based on outputs generated by the AI model. Further, the method 900 discloses transmitting performance information of the AI model to the target base station. The performance information may include the performance parameters of the AI model.

Thus, the methods 700, 800, and 900 leverage shared components between AI models of different configurations, enabling efficient reconfiguration by transferring only the configuration specific sub-blocks to the user equipment. This approach reduces bandwidth usage, accelerates the process of sharing AI models, and enhances resource utilization, thereby improving AI model management within wireless networks. Additionally, the methods 700 800 and 900 also boost the scalability and flexibility of AI applications in dynamic environments.

The sequence of operations of the method 900 need not be necessarily executed in the same order as they are presented. Further, one or more operations may be grouped together and performed in the form of a single operation, or one operation may have several sub-operations that may be performed in parallel or in a sequential manner. Meanwhile, the above-described method 900 may be performed by the AI model.

The disclosed method with reference to FIG. 9, or one or more operations of the UE 600 explained with reference to FIG. 6 may be implemented using software including computer-executable instructions stored on one or more computer-readable media (e.g., non-transitory computer-readable media, such as one or more optical media discs, volatile memory components (e.g., DRAM or SRAM), or non-volatile memory or storage components (e.g., hard drives or solid-state non-volatile memory components, such as flash memory components) and executed on a computer (e.g., any suitable computer, such as a laptop computer, net book, Web book, tablet computing device, smart phone, or other mobile computing device). Such software may be executed, for example, on a single local computer.

Furthermore, one or more computer-readable storage media may be utilized in implementing embodiments consistent with the disclosure. A computer-readable storage medium refers to any type of physical memory on which information or data readable by a processor may be stored. Thus, a computer-readable storage medium may store instructions for execution by one or more processors, including instructions for causing the processor(s) to perform operations or stages consistent with the embodiments described herein. The term "computer-readable medium" may be understood to include tangible items and exclude carrier waves and transient signals, i.e., be non-transitory. Examples include RAM, ROM, volatile memory, non-volatile memory, hard drives, compact disc (CD) ROMs, DVDs, flash drives, disks, and any other known physical storage media.

It will be understood by those within the art that, in general, terms used herein, and are generally intended as "open" terms (e.g., the term "including" may be interpreted as "including but not limited to," the term "having" may be interpreted as "having at least," the term "includes" may be interpreted as "includes but is not limited to," or the like). For example, as an aid to understanding, the detail description may contain usage of the introductory phrases "at least one" and "one or more" to introduce recitations. However, the use of such phrases may not be construed to imply that the introduction of a recitation by the indefinite articles "a" or "an" limits any particular part of description containing such introduced recitation to disclosure containing only one such recitation, even when the introductory phrases "one or more" or "at least one" and indefinite articles, such as "a" or "an" (e.g., "a" and/or "an" may typically be interpreted to mean "at least one" or "one or more") are included in the recitations, the same holds true for the use of definite articles used to introduce such recitations. In addition, even if a specific part of the introduced description recitation is explicitly recited, those skilled in the art will recognize that such recitation may typically be interpreted to mean at least the recited number (e.g., the bare recitation of "two recitations," without other modifiers, typically means at least two recitations or two or more recitations).

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device, cause the electronic device to perform a method of the disclosure.

Any such software may be stored in the form of volatile or non-volatile storage, such as, for example, a storage device like read only memory (ROM), whether erasable or rewritable or not, or in the form of memory, such as, for example, random access memory (RAM), memory chips, device or integrated circuits or on an optically or magnetically readable medium, such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method of any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A base station for sharing artificial intelligence (AI) models, the base station comprising:
memory, comprising one or more storage media, storing instructions; and
at least one processorcommunicatively coupled to the memory,
wherein the instructions, when executed by the at least one processor individually or collectively, cause the base station to:
receive user equipment (UE) capability information from a UE,
receive previous UE configuration data from a serving base station,
download, from a server, one or more configuration specific sub-blocks corresponding to at least one AI model at least based on the previous UE configuration data and the UE capability information, and
transmit one or more configuration specific sub-blocks along with channel state information (CSI) report configuration information to the UE.

2. The base station of claim 1,
wherein the UE capability information at least includes one or more AI based operations supported by the UE and one or more AI model download capability.

3. The base station of claim 1, wherein the instructions, when executed by the at least one processor individually or collectively, further cause the base station to:
receive, from the UE, performance information of the at least one AI model.

4. The base station of claim 1, wherein the instructions, when executed by the at least one processor individually or collectively, further cause the base station to:
download the one or more configuration specific sub-blocks corresponding to the at least one AI model further based on AI operations supported by the base station.

5. A server for managing artificial intelligence (AI) models, the server comprising:
memory, comprising one or more storage media, storing instructions; and
at least one processor communicatively coupled to the memory,
wherein the instructions, when executed by the at least one processor individually or collectively, cause the server to:
split an AI model into a plurality of blocks based on at least one input parameter and at least one configuration parameter, and
categorize the plurality of blocks as one or more common sub-blocks or one or more configuration specific sub-blocks for a base station at least based on dependency of the base station on the at least one input parameter and the at least one configuration parameter.

6. The server of claim 5, wherein the instructions, when executed by the at least one processor individually or collectively, further cause the server to:
receive, from the base station, a request for one or more sub-blocks, wherein the request for one or more sub-blocks comprises the one or more configuration specific sub-blocks or the common sub-block, and
transmit the requested one or more sub-blocks to the base station.

7. The server of claim 5, wherein the instructions, when executed by the at least one processor individually or collectively, further cause the server to:
assign a unique identifier comprising of a block number and a block identifier to the plurality of blocks of the AI model.

8. The server of claim 7, wherein the unique identifier is stored in the AI model execution information for sharing with channel state information (CSI) report configuration information,
wherein the block identifier indicates a flow of execution of the blocks of the AI model, and
wherein the block number corresponds to each block from among the plurality of blocks of the AI model.

9. A user equipment (UE) for loading of artificial intelligence (AI) models, the UE comprising:
memory, comprising one or more storage media, storing instructions; and
at least one processor communicatively coupled to the memory,
wherein the instructions, when executed by the at least one processor individually or collectively, cause the UE to:
transmit UE capability information to a target base station,
receive one or more configuration specific sub-blocks corresponding to an AI model along with channel state information (CSI) report configuration information from the target base station, wherein the CSI report configuration information comprises AI model execution information, and
configure the AI model based on the one or more configuration specific sub-blocks and the AI model execution information within the CSI report configuration information.

10. The UE of claim 9, wherein the instructions, when executed by the at least one processor individually or collectively, further cause the UE to:
receive, from a serving base station, one or more common sub-blocks corresponding to an AI model.

11. The UE of claim 10, wherein the AI model is configured further based on the one or more common sub-blocks and the AI model execution information.

12. The UE of claim 9, wherein the instructions, when executed by the at least one processor individually or collectively, further cause the UE to:
measure performance parameters of the AI model based on outputs generated by the AI model, and
transmit performance information of the AI model to the target base station, wherein the performance information includes the performance parameters of the AI model.
